(19) United States
(12) Patent Application Publication
(10) Pub. No.: US 2007/0248170 A1
(43) Pub. Date: Oct. 25, 2007

(54) Transmitting Apparatus, Receiving Apparatus, and Reproducing Apparatus

(76) Inventors: Masayuki Baba, Tokyo (JP); Hiroyuki Kurokawa, Tokyo (JP); Yoshiaki Kato, Tokyo (JP)

Correspondence Address: BIRCH STEWART KOLASCH & BIRCH, PO BOX 747, FALLS CHURCH, VA, 22040-0747, US

(21) Appl. No.: 11/628,661

(22) PCT Filed: Oct. 15, 2004
(86) PCT No.: PCT/JP04/15250

§ 371 Date: Dec. 6, 2006

(51) Int. Cl. H04N 11/04

(52) U.S. Cl. 375/240.25; 375/E07.138

(57) ABSTRACT

It is possible to conduct reproduction control so as to thin out frames or widen the frame interval without deterioration of a reproduction quality. A transmitting apparatus (1) includes an encoding unit (3) for temporally dividing media data having a temporal continuity and encoding the media data, a reproduction information generating unit (4) for generating the reproduction information on the basis of the contents of the media, and a transmitting unit (5) for transmitting the encoded media data and the generated reproduction information. Further, a receiving apparatus (11) includes a receiving unit (12) for extracting media encoded data having a temporal continuity and the reproduction information from the received data, a decoding unit (13) for decoding the media encoded data, and a reproducing unit (14) for reproducing the decoded media data that is decoded on the basis of the reproduction information.

### TECHNICAL FIELD

The present invention relates to a transmitting apparatus, a receiving apparatus, and a reproducing apparatus for enabling reproduction control without deteriorating reproduction.

### BACKGROUND ART

Up to now, there is a moving-picture reproducing apparatus that adjusts reproduction timing by changing a reproduction frequency in the case where a media is not reproduced at a desired timing due to excess or deficiency of data. Because the conventional moving-picture reproducing apparatus is capable of flexibly changing a reproduction frame rate, it is possible to smoothly reproduce a moving picture even under the circumstance of the convergence of transmission lines or the heavy load of a CPU (for example, refer to Patent Document 1).

For example, in the case where video data arrives later than an original receiving timing because transmission lines are converged, video data to be reproduced is temporarily short in a reproducing apparatus, and reproduction must be suspended, as a result of which it is difficult to view the moving image for a user.

For that reason, in the conventional method, a video frame interval to be reproduced is made broader than an original interval before the video data is short, thereby preventing the short of the video data. In this case, although the reproduction interval of the video is extended, a visual influence on the user is smaller than that in the case of suspending the reproduction.

Thereafter, the reproducing apparatus prevents overflow of a video buffer by making the video frame interval to be reproduced narrower than an original interval because there is the possibility that a video buffer induces overflow when the reproducing apparatus receives the video data that has been delayed on the transmission line at once. This makes it possible to prevent the disposal of a video and to shorten the delay in reproduction.

In the above manner, the reproduction frame rate of video is adjusted due to the remaining quantity of video buffer, to thereby prevent the overflow or underflow of the video buffer, and prevent a delay time in the production from extremely increasing. As a result, there is obtained video reproduction that is small in uncomfortable feeling for a person who views the video.

Patent Document 1: JP-A 7-327214

### DISCLOSURE OF THE INVENTION

### Problems to be solved by the Invention

A conventional moving-picture reproducing apparatus has suffered from such a problem that there occurs a visual influence such that a motion becomes slightly quick or slow because the reproduction interval of the frame is dynamically changed.

Also, in the case of using the conventional method to reproduce audio data, there arises such a problem that an audio frequency fluctuates and audio outputted sounds unusual.

In addition, some general purposes apparatus including a personal computer have such a problem that a reproduction frame interval cannot be changed and thus the conventional method is not applicable.

The present invention has been made to solve the above-mentioned problems, and an object of the present invention is to provide a transmitting apparatus, a receiving apparatus, and a reproducing apparatus which are capable of conducting reproduction control without changing a frame interval.

### MEANS FOR SOLVING THE PROBLEMS

A transmitting apparatus according to the present invention includes: encoding means for temporally dividing media data having a temporal continuity and encoding the divided media; reproduction information generating means for generating reproduction information based on the contents of media in a data unit that is encoded by the encoding means; and transmitting means for transmitting the media data that is encoded by the encoding means and the reproduction information that is generated by the reproduction information generating unit.

Further, a receiving apparatus according to the present invention includes: receiving means for extracting media encoded data having a temporal continuity and reproduction information related to the media encoded data from received data; decoding means for decoding the media encoded data from the receiving means; and reproducing means for reproducing media data that is decoded by the decoding means on the basis of the reproduction information from the receiving means.

Further, a reproducing apparatus according to the present invention includes: storage means for storing media encoded data having a temporal continuity and reproduction information related to the media encoded data in advance; reading means for reading the media encoded data and the reproduction information from the storage means; decoding means for decoding the media encoded data that is read from the reading means; and reproducing means that reproduces media data that is decoded by the decoding means on the basis of the reproduction information that is read from the reading means.

### EFFECTS OF THE INVENTION

According to the present invention, reproduction information that takes the contents of media encoding data into consideration is given to the media encoding data and transmitted, and reproduction control is conducted by using reproduction information. As a result, the reproduction control can be conducted without changing a frame interval.

### BRIEF DESCRIPTION OF THE DRAWINGS

FIG. 1 is a block diagram showing the configuration of a transmitting apparatus and a receiving apparatus according to a first embodiment of the present invention.

FIG. 2 is a diagram for explaining the operation of a reproduction control according to the first embodiment of the present invention, and showing an example of a case in which an audio waveform is reproduced.

FIG. 3 is a diagram for explaining the operation of a reproduction control according to the first embodiment of the present invention, and showing an example in which a reproduction timing is not adjusted.

FIG. 4 is a diagram for explaining the operation of a reproduction control according to the first embodiment of the present invention, and showing an example in which a reproduction timing is adjusted.

FIG. 5 is a diagram for explaining the operation of a reproduction control according to the first embodiment of the present invention, and showing another example in which a reproduction timing is adjusted.

FIG. 6 is a block diagram showing the configuration of a reproducing apparatus according to a second embodiment of the present invention.

### BEST MODES FOR CARRYING OUT THE INVENTION

### First Embodiment

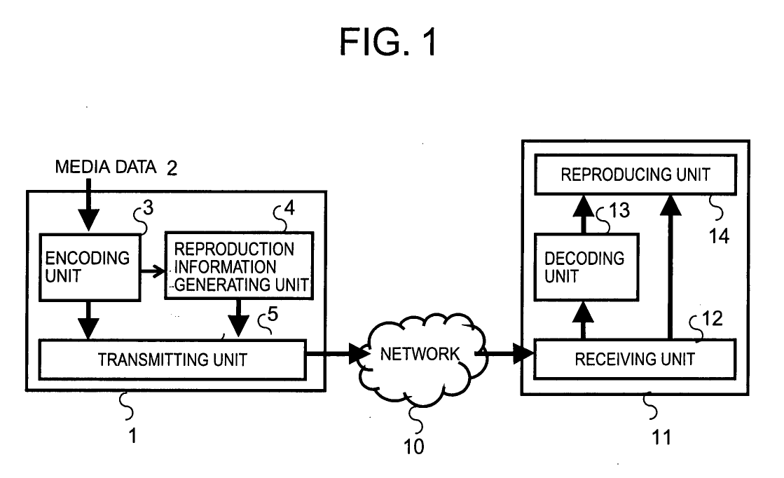

FIG. 1 is a block diagram showing the configuration of a transmitting apparatus and a receiving apparatus according to a first embodiment of the present invention. Referring to FIG. 1, a transmitting apparatus 1 and a receiving apparatus 11 are connected via a network 10 to conduct transmission and reception of media data. Media data 2 that is inputted to the transmitting apparatus 1 is temporally continuous data such as video or audio. An encoding unit 3 encodes the media data 2, and generates the encoded data. A reproduction information generating unit 4 generates the reproduction information by a data unit encoded by the encoding unit 3. A transmitting unit 5 transmits the encoded data that is generated by the encoding unit 3 and the reproduction information that is generated by the reproduction information generating unit 4 together as one encoding unit.

A receiving unit 12 of the receiving apparatus 11 extracts the encoded data and the reproduction information from the data that is received via the network 10. A decoding unit 13 decodes the encoded data. A reproduction unit 14 reproduces media data that has been decoded on the basis of the reproduction information. FIG. 1 is a structural diagram pertaining to the transmission of one piece of media data, but a plurality of units having the same function may be provided, thereby making it possible to transmit a plurality of media data at the same time.

Subsequently, the operation will be described. First, the temporally continuous media data 2 is divided into arbitrary units and encoded by the encoding unit 3 of the transmitting apparatus 1 to generate encoded data. The reproduction information generating unit 4 generates the reproduction information in a data unit that has been encoded by the encoding unit 3. In this case, the reproduction information is indicative of auxiliary information such as importance in the reproduction in the case of taking the contents as the contents of the media data into consideration. In the generation of the reproduction information of the media data, the reproduction information generating unit 4 obtains information related to the media data from the encoding unit 3. For example, in the case of the audio data, the encoding unit 3 detects the magnitude of an electric energy (i.e., power) of the audio when the encoding unit 3 conducts the encoding operation, and then notifies the reproduction information generating unit 4 of the detected magnitude, whereby the reproduction information generating unit 4 records the fact as the reproduction information because the reproduced audio is not largely influenced even if the audio data that is small in the electric energy is not reproduced. Then, the transmitting unit 5 transmits the encoded data that has been generated by the encoding unit 3 and the reproduction information that has been generated by the reproduction information generating unit 4 together. As a method therefor, an encoding unit for transmitting the encoded information is generated, the reproduction information is set in the header portion thereof, and the encoded data is set in the information portion of the encoding unit.

The data that has been transmitted from the transmitting unit 5 of the transmitting apparatus 1 is received by the receiving unit 12 of the receiving apparatus 11 via the network 10. The receiving unit 12 separates the encoded data and the reproduction information from the received data, and then transmits the encoded data and the reproduction information to the decoding unit 13 and the reproducing unit 14, respectively. The decoding unit 13 decodes the encoded data and transmits the decoded data as the media data to the reproducing unit 14. The reproducing unit 14 reproduces the decoded media data on the basis of the reproduction information. In this way, in the case where the encoded data is reproduced by using the reproduction information, for example, data that is low in the electric energy of the audio is regarded as noises and prevented from being outputted, thereby making it possible to prevent the noises from being reproduced. On the other hand, it is possible to output all of the audio data as usual.

As described above, the transmitting apparatus 1 is capable of recognizing the information (i.e., importance) in the reproduction in each of the encoded data units because the transmitting apparatus 1 transmits the reproduction information in addition to the encoded data. Also, the receiving apparatus 11 is capable of selectively reproducing only the encoded data which appears to be necessary since the receiving apparatus 11 controls enabling/disabling of the reproduction in each of the encoding data on the basis of the reproduction information.

Also, the electric energy concerning the contents of the media data is included in the reproduction information, thereby making it possible to selectively reproduce only the media data that is large in the electric energy in the case where all of the media data cannot be reproduced due to some circumstances. At the same time, it is possible to transmit information necessary for the user because the electric energy is substantially important.

In the case of the audio data, because the size and the frequency of the audio waveform are important elements, the encoding unit 3 detects the electric energy (i.e., power) of the audio in conducting the encoding operation, and notifies the reproduction information generating unit 4 of the magnitude of the electric energy. The reproduction information generating unit 4 regards the notified magnitude as the electric energy of the sound volume, and sets its electric energy as the reproduction information corresponding to the respective encoded data.

The receiving apparatus 11 reproduces the encoded data on the basis of the reproduction information, but is capable of not reproducing the data that is small in the electric energy. The audio data is not outputted by conducting no reproduction. However, an audience does not feel deterioration of the audio quality because the volume of the data is small in the audio output.

As described above, the information on the electric energy is included in the reproduction information, thereby making it possible to output only a portion of the respective encoded data which is important in terms of the contents.

In the case where some image is always reproduced as with a video, the portion that is important in terms of the contents is a portion including a motion in the image. In other words, contents have more important meaning as the amount of change is larger. Under the circumstances, when the video data is encoded by the encoding unit 3, the amount of change from a previous frame is represented by the electric energy, and the magnitude thereof is notified to the reproduction information generating unit 4. The reproduction information generating unit 4 regards the notified electric energy as the amount of change of that frame, and sets the amount of change as the reproduction information corresponding to the respective encoded data.

The receiving apparatus 11 reproduces the encoded data on the basis of the reproduction information, but is capable of not reproducing the encoded data that is small in the amount of change. A frame of the video is skipped by not conducting the reproduction, but the audience does not feel the deterioration of the video quality because a difference from a frame immediately before that frame is small. For example, in the case where the performance of a CPU is not sufficient, the frame skip is conducted as described above, thereby making it possible to reduce a load of the CPU without deteriorating the reproduction quality.

As described above, the information such as the amount of change is included in the reproduction information, thereby making it possible to output only a portion of the respective encoded data which is important in terms of the contents.

Also, the continuity of the contents of the media data is included in the reproduction information, thereby making it possible to recognize a portion having no continuity, that is, a portion of a change of scenes or a disconnected conversation, at the time of reproduction.

For example, in the case of the audio data, a word is one continuous audio. A silent portion is also included in the word, and the electric energy at that time is small, but the word has the continuity as one word including the silent portion. As the detecting method of the continuity of the audio, the electric energy is monitored, there is a high possibility that the portion that is small in the electric energy becomes a discontinuous portion. However, because the silent portion is included even in the word as described above, it is proper to regard the portion that has been small in the electric energy for a given period of time or longer as the discontinuous portion. As described above, when the electric energy is detected by the encoding unit 3, a change in the electric energy is monitored, thereby making it possible to detect the discontinuous point, and to include the continuity of the media in the reproduction information.

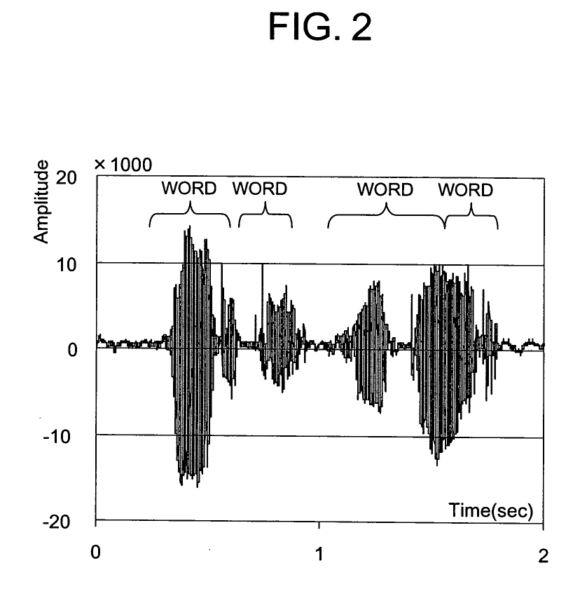

FIG. 2 shows an example of the audio waveform, and shows the waveform of a speech composed of four words that are “Honjitu/wa/seiten/nari”. The electric energy becomes large at a portion in which the amplitude is large, but a portion that is small in the electric energy is included in the word. Because portions that are small in the electric energy are continued for a long period of time before and after those four words, those portions can be regarded as portions having no continuity as discontinuities between segments.

Also, in the case of the video data, as a method of detecting the discontinuous portion in terms of the contents, that is, the change of scenes, it is possible to monitor a temporal change in the amount of change. In general, the portion of the change of scenes becomes large in the amount of change because the image is changed. However, because the amount of change becomes large even in the video data that is large in the motion, as a method of distinguishing those portions from each other, a point that becomes temporarily large in the amount of change can be regarded as a discontinuous point. This is because a video that is large in the amount of motion becomes large in the amount of change during a certain period of time. As described above, a temporal change in the amount of change is monitored, thereby making it possible to detect the discontinuous point of the video.

As described above, the continuous information is included in the reproduction information, to thereby make it possible to recognize the discontinuity of the contents of the media data.

Also, when the encoded data and the reproduction information are transmitted by the transmitting unit 5, the reproduction information is transmitted as the meta data, separately from the encoded data without being combined as one encoded unit, to thereby make it possible to transmit the encoded data in the conventional method, thus ensuring the mutual connectivity with the conventional apparatus. Then, the reproduction information is transmitted as meta data, thereby making it possible to perform the reproduction control as the occasion demands.

As described above, when the reproduction information is transmitted as the meta data, separately from the encoded data, it is possible to transmit the encoded data in the conventional method, and it is also possible to use the reproduction information as the occasion demands.

Also, in transmitting the encoded data and the reproduction information by the transmitting unit 5, it is possible to determine whether the encoded data is to be transmitted according to the contents of the reproduction information. For example, in the case where the contents of the reproduction information pertained to some encoded data has no continuity and is small in the electric energy or the amount of change, it is possible to prevent the encoded data from being transmitted.

With the above-mentioned operation, in the case where the network is converged and not all of the encoded data to be transmitted are likely to be transmitted, it is possible to selectively transmit the encoded data on the basis of the contents of the reproduction information.

As described above, since whether the encoded data is to be transmitted is determined on the basis of the reproduction information, it is possible to transmit only the encoded data that appears to be effective.

Also, as a method of controlling the reproduction of the encoded data by means of the reproduction information by the receiving apparatus 11, in the case where the contents of the reproduction information has no continuity and is small in the electric energy, it is possible to prevent those data from being reproduced.

For example, in the case of the audio data, the silent portion is included in the word and the electric energy at that time is small, but the continuity as one word including the silent portion is important. Therefore, the encoded data in a continuous section should be reproduced as it is without being subjected to specific control. If the reproduction is controlled for that portion, a difference from the original audio is apparent. Because the audio data that is silent and has no continuity does not make any difference from the original audio even if the portion including such the audio data is not reproduced, it is possible to stop the reproduction. The deterioration of the audio quality cannot be recognized even if subsequent audio data is outputted as the occasion demands.

As described above, in the case where the contents of the reproduction information has no continuity and is small in the electric energy, the encoded data is prevented from being reproduced, thereby making it possible to reduce a reproduction load with no deterioration of the reproduction quality.

Also, as a method of controlling the reproduction of the encoded data by means of the reproduction information by the receiving apparatus 11, in the case where the contents of the reproduction information has no continuity and is small in the amount of change, it is possible to prevent the encoded data from being reproduced.

For example, in the case of the video data, a scene is one continuous image, and when there is a motion in the image, the importance becomes high. As a result, the video data should be reproduced. On the other hand, in a scene having no motion at all, the scene has the continuity but the importance is low, so the image quality is not largely deteriorated even if the image is thinned out. That is, a still picture of 30 frames/sec is not distinguishable from a still picture of 10 frames/sec. However, the fact that the thinned-out image is not reproduced does not mean the image is not outputted at all, but it is necessary to conduct a process of continuously reproducing the previous video frame in order to maintain the continuity.

As described above, in the case where the contents of the reproduction information have continuity, and are small in the amount of change, since the encoded data is not reproduced, it is possible to reduce a reproduction load with no deterioration of the reproduction quality.

Also, the reproduction information is represented by information elements such as the continuity, the electric energy, and the amount of change. However, because the information required in the reproduction is different in each of the media, the reproduction control is conducted by using the information element according to the media. In other words, as described in the above-mentioned example, for example, the electric energy is used in the case of the audio media, and the amount of change is used in the case of the video media, thereby making it possible to perform the reproduction control without deteriorating the reproduction quality.

As described above, the contents of the reproduction information to be used are selected according to the media, thereby making it possible to perform the reproduction control taking the characteristics of the media into consideration.

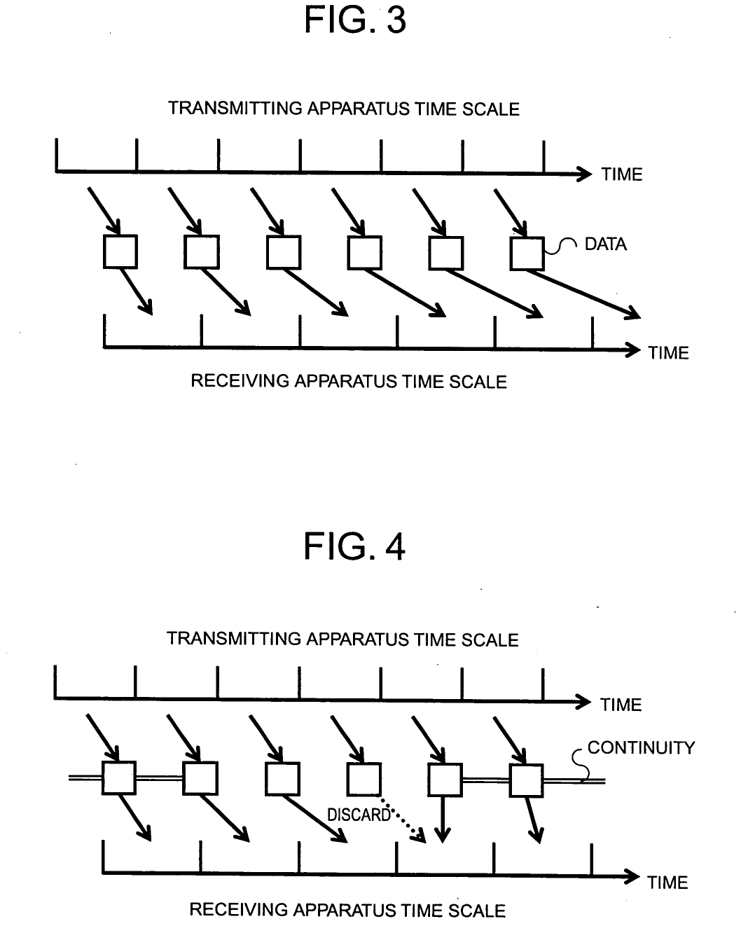

FIGS. 3 and 4 are diagrams showing one example of the reproduction control operation according to the present invention. The transmitting apparatus 1 generates and transmits the data, for example, at intervals of 100 ms, and the receiving apparatus 11 receives and reproduces the data at intervals of 100 ms. In this situation, in the case where the operation clocks of the transmitting apparatus 1 and the receiving apparatus 11 deviate from each other, periods of time required for processing the data of the same 100 ms become different therebetween. In the case where the operation clock of the transmitting apparatus 1 is quicker, as shown in FIG. 3, because the reproduction interval in the receiving apparatus 11 is broader than that of the transmitting apparatus 1, the reproduction timing of the media data is gradually delayed.

In FIG. 4, the continuity between the respective data is indicated by a horizontal line between data. In FIG. 4, first data and second data have continuity, and third data and fourth data have no continuity. Also, fifth data and subsequent data have continuity. Those continuities are shown on the basis of the reproduction information.

Under the circumstances, as shown in FIG. 4, fourth data that is intended to be reproduced by a fourth time slot of the receiving apparatus 11 is discarded, and the fifth data is reproduced in the time slot of the fourth data, thereby making it possible to recover the delay of the reproduction timing. Then, because the discarded fourth data is data of a portion having no continuity, the data does not influence the reproduction quality of media.

As described above, the previous media data having no continuity is discarded, and reproduction control is so conducted as to reproduce new media data, thereby making it possible to adjust the reproduction timing.

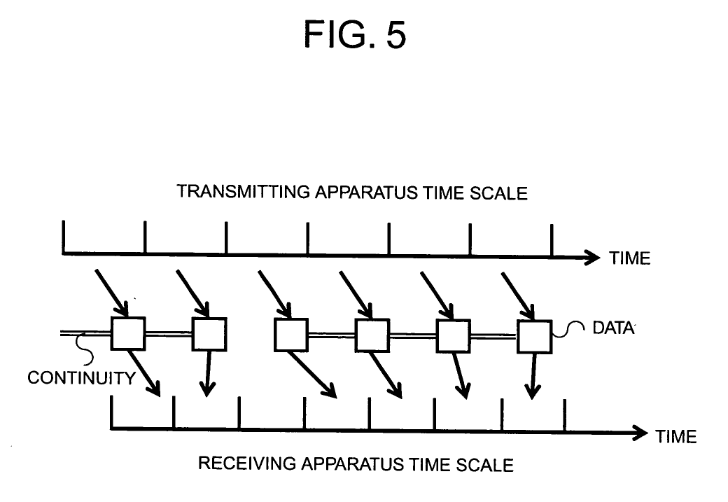

FIG. 5 shows an example of another reproduction control operation according to the present invention. The circumstance is the same as that of FIG. 3, but FIG. 5 shows an example in which the operation clock of the receiving apparatus 1 is quicker. The first and second data has the continuity, data becomes discontinuous once, and the third data and subsequent data have continuity.

Because the operation clock of the receiving apparatus 11 is quicker, the reproduction operation that goes over the transmitted data is conducted. Because of this, there exists a time slot in which data is short and nothing can be reproduced.

Under the circumstances, the reproduction is suspended at the portion having no continuity so as not to influence the reproduction quality of the media. That is, in FIG. 5, because the continuity is disconnected between the second and third data, even if a time is slightly extended between the reproduction of those data, the time extension does not influence the reproduction quality. Therefore, nothing is reproduced in the third time scale of the receiving apparatus 11, and the third data is reproduced in the fourth time scale. With this operation, slightly short data can be temporarily prevented from being short.

In the case of audio, there is nothing unusual about the media even if no audio is outputted in the third time scale whereas in the case of video, anything unusual about the media is eliminated by continuously outputting the image that is outputted by the second time scale in the third time scale.

As described above, when the media data of a portion having no continuity is delayed and outputted, it is possible to adjust the reproduction timing.

In the case where the reproducing unit 14 is incapable of adjusting the reproduction clock at the receiving timing of the media data in reproduction of the media data that is transmitted from the decoding unit 13, the excess and deficiency of the reproduction data occurs in the reproducing unit 14 as described above.

Under the circumstances, the number of media data which has not yet completed being reproduced among the media data that is transmitted to the reproducing unit 14 from the decoding unit 13 is counted, and the media data is discarded if the counted number is large, and the reproduction timing of the media data is delayed in the case where the counted number is small so that the number approaches a certain value. In this situation, the media data to be discarded or delayed which has no continuity is selected, thereby making it possible to suppress the deterioration of the reproduction quality.

As described above, in order to make the receiving speed and the reproduction speed of the media data coincident with each other, the media data is discarded or delayed in the reproduction by using the reproduction information, thereby making it possible to prevent the delay in the reproduction from increasing or the important reproduction from being discarded.

In the case of receiving and reproducing a plurality of media, for example, in the case where the video and the audio are reproduced at the same time, when the reproduction timing is adjusted in each of the media, synchronization (i.e., lip-sync) between the video and the audio is not attained. That is, a state where the shape of a mouth and audio while talking do not coincide with each other occurs. For that reason, the reproduction timing is adjusted so that total delay times of the respective media data substantially coincide with each other on the display unit, thereby making it possible to keep a synchronization between the media.

As described above, the reproduction timing is adjusted so that the total delay times of the plurality of media data substantially coincide with each other, thereby making it possible to synchronize the reproduction in the plurality of media.

### Second Embodiment

The above-mentioned first embodiment pertains to the reproduction control as the communication data, and a second embodiment will be described below, in which the reproduction control is conducted, for example, in the case of reproducing the stored encoded data while communication is not in progress.

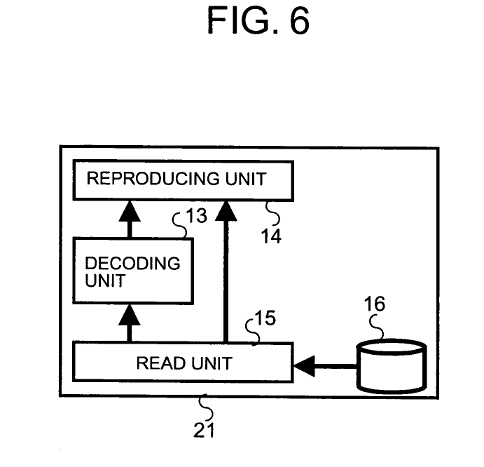

FIG. 6 is a block diagram showing the construction of a reproducing apparatus 21 according to a second embodiment in the case described above. In the second embodiment shown in FIG. 6, the reproducing apparatus 21 reproduces the encoded media data, and includes a storage unit 16 for storing media encoded data having a temporal continuity and the reproduction information in advance, a read unit 15 for reading the media encoded data and the reproduction information from the storage unit 16, an decoding unit 13 for decoding the media encoded data that has been read by the read unit 15, and a reproduction unit 14 for reproducing the media data that has been decoded by the decoding unit 13 on the basis of the reproduction information that has been read by the read unit 15.

Subsequently, the operation will be described. First, the encoded data and the reproduction information are stored in the storage unit 16 of the reproducing apparatus 21. The encoded data and the reproduction information are obtained by a method of, for example, receiving and storing the encoded data and the reproduction information that have been transmitted from the transmitting apparatus 1 of the first embodiment on the network, and stored in the storage unit 16 in advance.

The read unit 15 reads the encoded data and the reproduction information from the storage unit 16, and transmits the read data and information to the decoding unit 13 and the reproducing unit 14, respectively. The decoding unit 13 decodes the encoded data and transmits the decoded data to the reproduction unit 14 as media data. The reproducing unit 14 reproduces the decoded media data on the basis of the reproduction information. In this situation, the reproduction unit 14 may conduct reproduction control such as skipping or delaying the media data when the reproduction unit 14 can recognize that the reproduction quality of the media is not influenced by those kind of control on the basis of the reproduction information.

For example, in the case where the reproduction performance of the reproducing apparatus is poor, and all of the media data cannot be reproduced, it is possible to reproduce the media data while thinning out the media data. In this situation, it is possible to thin out only the media data so as not to deteriorate the reproduction quality by using the reproduction information.

As described above, since the encoded data including the reproduction information is used as the storage data, and the reproduction control is conducted on the basis of the reproduction information, it is possible to conduct various reproduction control which does not induce the deterioration of the reproduction quality.

In the case of the receiving apparatus 11, the media is reproduced depending on the interval of the received data, but in the case of the reproducing apparatus 21 that does not depend on the communication, it is possible to freely change the reproduction interval. Under the circumstances, a portion that is not important in terms of the contents, it may be desired to skip an image, for example, that hardly has the motion. The encoded data that is small in the amount of change is recognized by the reproduction information, and such the encoded data is skipped and reproduced in the reproduction unit 14, thereby making it possible to provide only the image of a portion that is large in the amount of change to the user.

Likewise, in the case of the audio data, the encoded data that is small in the electric energy, that is, not large in the sound volume is recognized by the reproduction information, and the encoded data is not reproduced, thereby making it possible to reproduce only a portion of conversation among the audio data of a long period of time. However, when whether the data is reproduced or not is determined according to only the electric energy, there is the possibility that the silent portion in a word is also skipped. Therefore, it is possible to keep the audio waveform of the work as it is by skipping only the encoded data that has no continuity and is small in the electric power.

As described above, since the reproduction of the media data that is small in the electric energy or the amount of change is skipped on the basis of the reproduction information, it is possible to reproduce only the important portion in terms of the contents.

1. A transmitting apparatus, comprising:
encoding means for temporally dividing media data having a temporal continuity and encoding the divided media data;
reproduction information generating means for generating reproduction information based on the contents of media in a data unit that is encoded by the encoding means; and
transmitting means for transmitting the media data that is encoded by the encoding means and the reproduction information that is generated by the reproduction information generating means.

2. The transmitting apparatus according to claim 1, characterized in that the transmitting means combines the reproduction information that is generated by the reproduction information generating means with the media data that is encoded by the encoding means to generate an encoded unit and sequentially transmits the encoded unit.

3. The transmitting apparatus according to claim 1, characterized in that the transmitting means transmits the reproduction information that is generated by the reproduction information generation unit means as meta data, separately from the media data that is encoded by the encoding means.

4. The transmitting apparatus according to claim 1, characterized in that:
the encoding means detects the electric energy of the media data that is temporally divided in encoding; and
the reproduction information generating means sets the electric energy that is detected by the encoding means as the reproduction information.

5. The transmitting apparatus according to claim 1, characterized in that:
the encoding means represents an amount of change from the media data which is divided immediately before encoding by the electric energy; and
the reproduction information generating means regards the electric energy that is calculated by the encoding means as a magnitude of a change in the contents of the media, and sets the electric energy as the reproduction information.

6. The transmitting apparatus according to claim 1, characterized in that:
the encoding means detects the electric energy of the media data that is temporally divided in encoding; and
the reproduction information generating means sets the information related to the continuity of the contents of the media data based on the amount of change of the electric energy which is detected by the encoding means as the reproduction information.

7. The transmitting apparatus according to claim 1, characterized in that the transmitting means determines whether the encoded data can be transmitted according to the contents of the reproduction information.

8. A receiving apparatus, comprising:
receiving means for extracting media encoded data having a temporal continuity and reproduction information related to the media encoded data from received data;
decoding means for decoding the media encoded data from the receiving means; and
reproducing means for reproducing media data that is decoded by the decoding means on the basis of the reproduction information from the receiving means.

9. The receiving apparatus according to claim 8, characterized in that the reproducing means suspends the reproduction of related media data when contents of the reproduction information has no continuity of contents of the media data, and electric energy is smaller than a predetermined value.

10. The receiving apparatus according to claim 8, characterized in that the reproducing means reproduces the related media data while thinning out the media data when the contents of the reproduction information has no continuity of the contents of the media data, and the electric energy is smaller than a predetermined value.

11. The receiving apparatus according to claim 8, characterized in that the reproducing means selects the contents of the reproduction information to be used according to a kind of media, and changes a reproduction control method in each of the media.

12. The receiving apparatus according to claim 8, characterized in that in the case where the contents of the received reproduction information has no continuity, when the previous media data waits for reproduction, the reproducing means discards the received reproduction information, and reproduces the media data.

13. The receiving apparatus according to claim 8, characterized in that in the case where the contents of the received reproduction information has no continuity, the reproducing means delays and reproduces the media data in a reproducing unit.

14. The receiving apparatus according to claim 8, characterized in that the reproducing means delays the discard of the media data or the reproduction timing with reference to the reproduction information so that the number of received samples and the number of reproduced samples per unit time of the media data substantially coincide with each other.

15. The receiving apparatus according to claim 8, characterized in that the reproducing means delays the discard of the media data or the reproduction timing with reference to the reproduction information so that the total delay times of a plurality of received media data substantially coincide with each other.

16. A reproducing apparatus, characterized by comprising:
storage means for storing media encoded data having a temporal continuity and reproduction information related to the media encoded data in advance;
reading means for reading the media encoded data and the reproduction information from the storage means;
decoding means for decoding the media encoded data that is read from the reading means; and
reproducing means that reproduces media data that is decoded by the decoding means on the basis of the reproduction information that is read from the reading means.

17. The reproducing apparatus according to claim 16, characterized in that the reproducing means skips the media data that is designated as being small in the amount of change or the electric energy by the reproduction information, and conducts reproduction.
